(19) United States
(12) Patent Application Publication
(10) Pub. No.: US 2008/0013338 A1
(43) Pub. Date: Jan. 17, 2008

(54) Opticle diffusing sheet and backlight module

(75) Inventor: Chung Tai Huang, Taoyuan County (TW)

Correspondence Address: BIRCH STEWART KOLASCH & BIRCH, PO BOX 747, FALLS CHURCH, VA, 22040-0747, US

(73) Assignee: Glory Sun Opto-Electronic Corp.

(21) Appl. No.: 11/582,306

(22) Filed: Oct. 18, 2006

(30) Foreign Application Priority Data
Jul. 14, 2006 (TW) 095125947

(51) Int. Cl. F21V 7/04

(52) U.S. Cl. 362/606; 362/627

(57) ABSTRACT

An optical diffusing sheet includes a body and a plurality of light-shielding dots. The light-shielding dots are disposed on a surface of the body and are adjacent to an edge of the body. At least a portion of the adjacent light-shielding dots have different intervals. A backlight module including the optical diffusing sheet is also disclosed.

### BACKGROUND OF THE INVENTION

1. Field of Invention

The invention relates to an optical diffusing sheet and a backlight module. In particular, the invention relates to an optical diffusing sheet and a backlight module with light-shielding dots.

2. Related Art

Thanks to developments in display technology, conventional cathode ray tube (CRT) display devices are gradually being replaced by liquid crystal displays (LCDs). LCDs have been used in many electronic products, such as laptop computers, televisions, and desktop monitors. An ordinary LCD mainly consists of an LCD panel and a backlight module.

As shown in FIG. 1, a conventional backlight module 1 includes a light source 11, a light guiding plate (LGP) 12, an optical diffusing sheet 13, and two prism sheets 14. The light source 11 is disposed in the vicinity of a light incident surface 121 of the LGP 12. The optical diffusing sheet 13 is disposed in the vicinity of a light outgoing surface 122 of the LGP 12. The two prism sheets 14 are disposed in the vicinity of on one side of the optical diffusing sheet 13. Additionally, several printing dots 124 are formed on the bottom surface 123 of the LGP 12 to scatter light.

When the light source 11 emits light, the light enters the LGP 12 via the light incident surface 121 and experiences total reflection inside the LGP 12. When the light passes through the printing dots 124 of the LGP 12, it is scattered and the total reflection is destroyed. Some light is deflected out of the light outgoing surface 122 of the LGP 12. When the light passes through the light diffusing sheet 13, the light diffusing sheet 13 makes the light distribution more even. The prism sheets 14 can correct the light traveling direction in order to converge the light and increase the brightness.

In the backlight module 1, the light source 11 is disposed in the vicinity of the light incident surface 121 of the LGP 12. Therefore, the brightness of the light outgoing surface 122 is not uniform. The region close to the light incident surface 121 is brighter than the other regions. Please refer to FIG. 2, which is the top view of the optical diffusing sheet 13 and the light source 11 in FIG. 1. Conventionally, to solve this problem, a light-shielding strap 132 and many printing dots 133 are disposed on the edge 131 of the optical diffusing sheet 13 that is closer to the light source 11 to absorb or reflect some of the light falling into this region. Since the location of the light-shielding strap 132 is outside the visible region, a long light-shielding strap 132 is allowed. However, in the visible region, a long light-shielding strap 132 is not suitable because it blocks too much light and affects the image quality. Instead, many printing dots 133 are used. Using the light-shielding strap 132 and the printing dots 133, the region in the vicinity of the light source 11 does not appear too bright, making the brightness of the entire light outgoing region more uniform.

Although this method can make the brightness more uniform, the outer diameter of the printing dots is about 0.1 mm. The size of pixels of modern display panels is, however, less than 0.3 mm. It is expected to become smaller as the technology improves. Therefore, the printing dot 133 almost blocks half of a pixel. Additionally, these printing dots 133 are distributed at equal intervals (see the exploded view in FIG. 2) and are of the same size in the prior art. Consequently, a mura defect occurs on the screen as light is regularly blocked. This deteriorates the quality of the backlight module 1.

Therefore, it is an important subject to improve the quality of backlight modules by providing an optical diffusing sheet and a backlight module to solve the problem of inhomogeneous light distributions and by preventing the occurrence of mura defects.

### SUMMARY OF THE INVENTION

In view of the foregoing, the invention is to provide an optical diffusing sheet and a backlight module that can solve the problem of inhomogeneous light distributions and avoid the occurrence of mura defects, thereby increasing the overall light-emitting quality.

To achieve the above, the invention discloses an optical diffusing sheet, which includes a body and a plurality of light-shielding dots. The light-shielding dots are disposed on a surface of the body and are adjacent to an edge of the body. At least a portion of the adjacent light-shielding dots have different intervals.

To achieve the above, the invention also discloses a backlight module, which includes a light source, an LGP, and an optical diffusing sheet. The LGP is disposed in the vicinity of the light source. The optical diffusing sheet is disposed on a light outgoing surface of the LGP, and includes a body and a plurality of light-shielding dots. The light-shielding dots are disposed on a surface of the body and are adjacent to an edge of the body. At least a portion of the adjacent light-shielding dots have different spacing intervals.

In summary, the optical diffusing sheet and the backlight module of the invention have a body and a plurality of light-shielding dots. The light-shielding dots are disposed on a surface of the body, adjacent to the edge of the surface. At least a portion of the adjacent light-shielding dots have different intervals. The light-shielding dots can absorb or reflect some of the light in the vicinity of the light source, so that the brightness of the light-emitting area is more uniform. In comparison with the prior art, at least a portion of the light-shielding dots of the optical diffusing sheet have different intervals and sizes. Therefore, they do not block the pixel light in a regular way. This prevents the occurrence of mura defects so as to increase the light-emitting efficiency of the entire backlight module and to improve the image quality.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional backlight module;

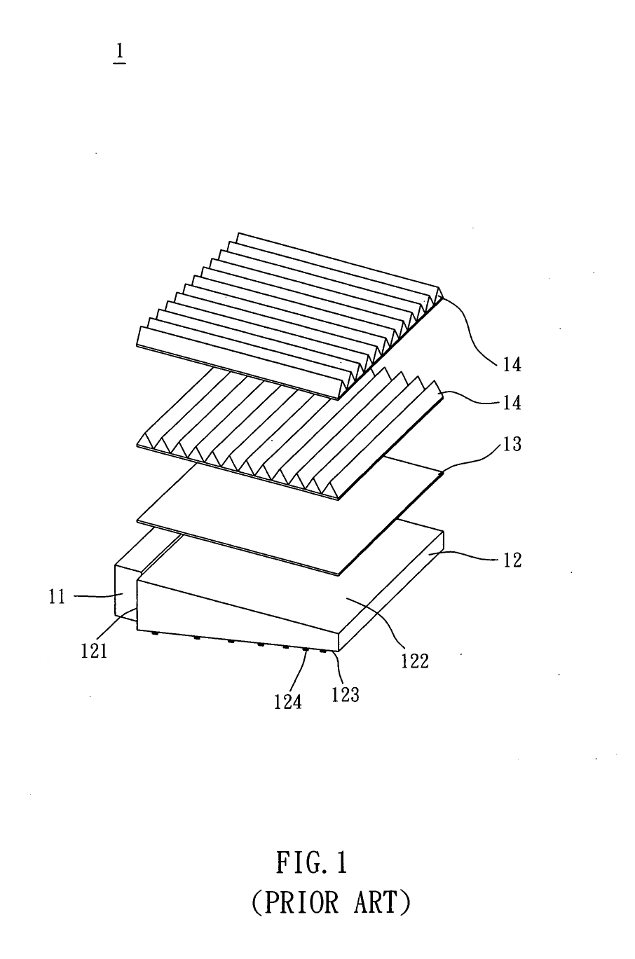

FIG. 2 is a schematic view of the printing dots on the conventional optical diffusing sheet;

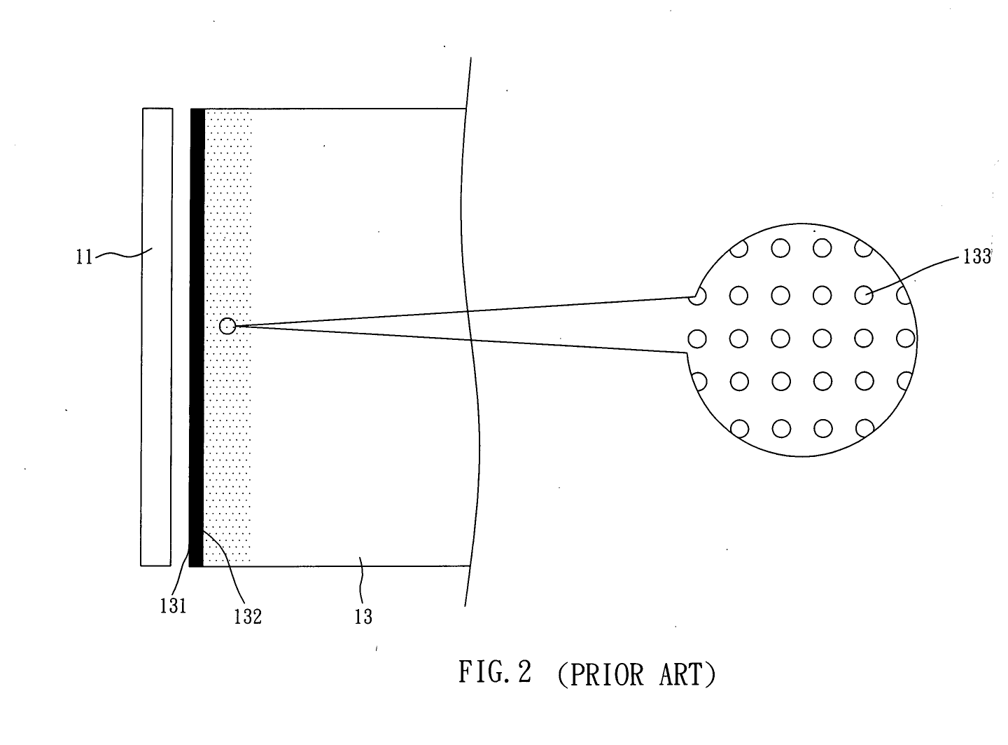

FIG. 3 is a schematic view of a backlight module according to a preferred embodiment of the invention;

FIG. 4 is another schematic view of the disclosed backlight module; and

FIG. 5 is a schematic view of the light-shielding dots on an optical diffusing sheet according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

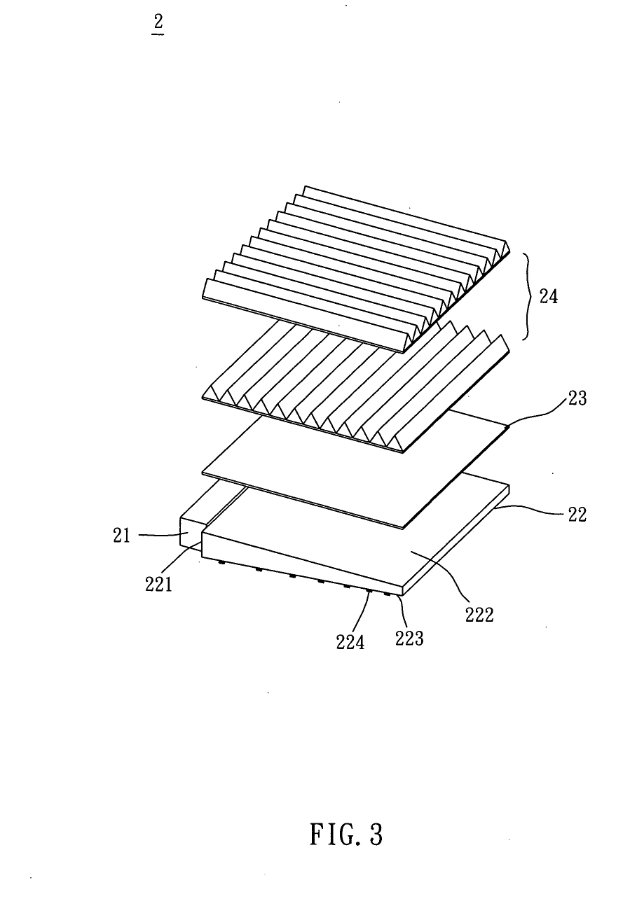

As shown in FIG. 3, a preferred embodiment of the backlight module 2 includes a light source 21, an LGP 22, and an optical diffusing sheet 23.

The light source 21 is disposed in the vicinity of a light incident surface 221 of the LGP 22. In this embodiment, the backlight module 2 is a side-emitting backlight module. The light source 21 can be a cold cathode fluorescent lamp (CCFL), an external electrode fluorescent lamp (EEFL), a light-emitting diode (LED), or a high pressure mercury lamp (HPML).

The LGP 22 is disposed in the vicinity of the light source 21. The LGP 22 is made of a transparent material, such as polymethyl methacrylate (PMMA). A bottom surface 223 of the LGP 22 has a plurality of printing dots 224 for scattering light. The LGP 22 can have a wedge or rectangular shape.

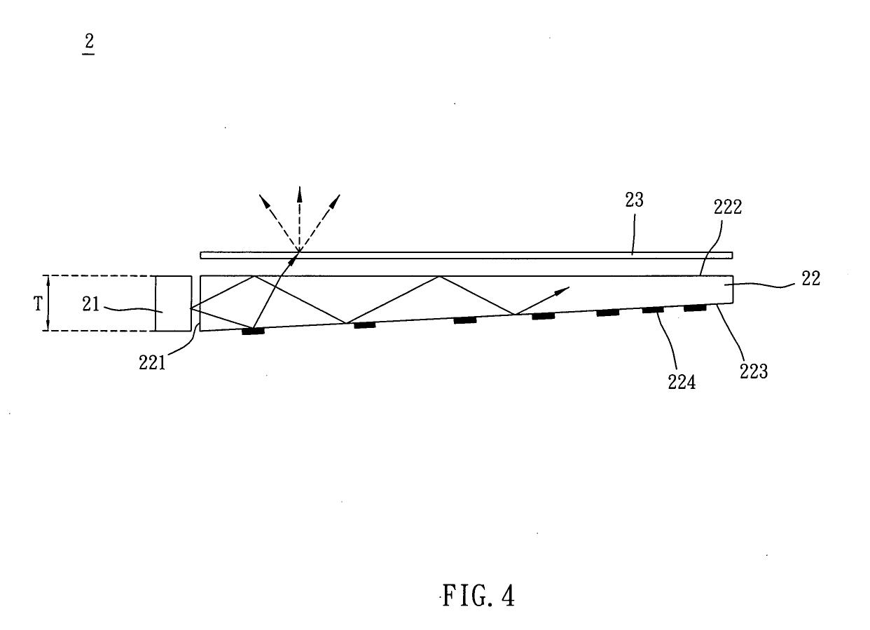

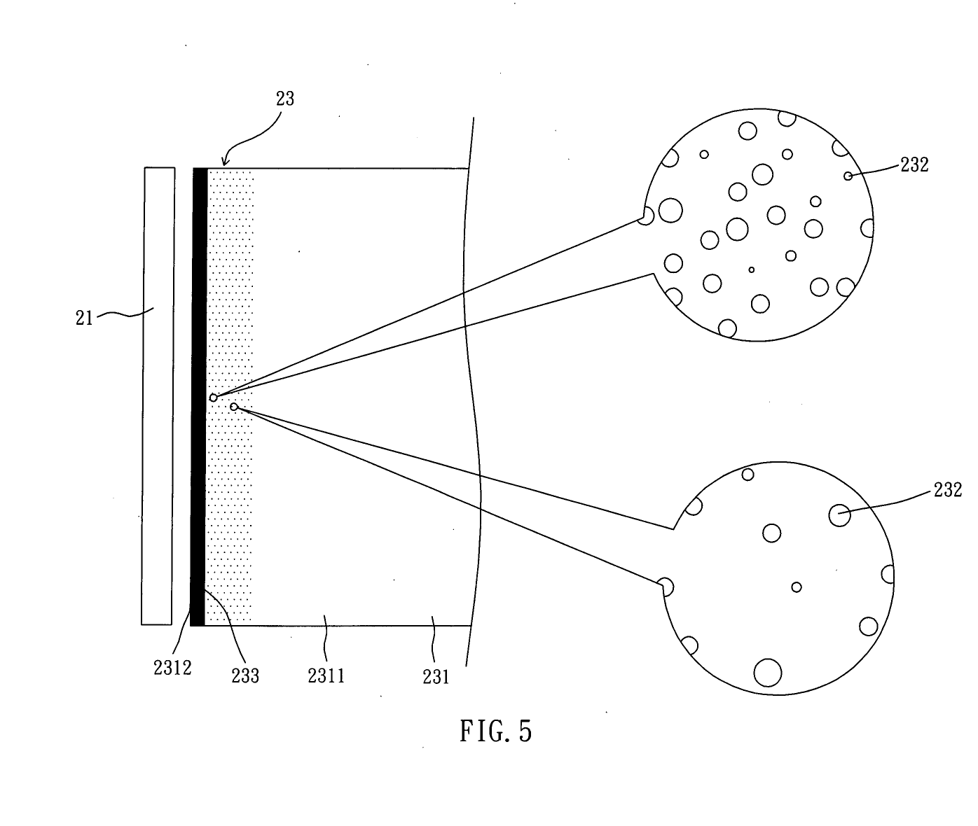

Please refer simultaneously to FIGS. 4 and 5, where FIG. 5 is a top view of the light source 21 and the optical diffusing sheet 23 in FIG. 3. The optical diffusing sheet 23 is disposed in the vicinity of a light outgoing surface 222 of the LGP 22. It includes a body 231 and several light-shielding dots 232 (see the exploded views in FIG. 5). The light-shielding dots 232 are disposed on one surface 2311 of the body 231, adjacent to one edge 2312 of the body 231. The light source 21 is adjacent to the edge 2312 of the body 231.

In this embodiment, at least a portion of the adjacent light-shielding dots 232 have different intervals (as shown in the exploded views in FIG. 5). The intervals of the adjacent light-shielding dots 232 can be determined in two ways. One is to compute them from experience values, and the other is to obtain them by random sampling according to distance range. The light-shielding dots 232 are thus distributed irregularly. Additionally, the sizes of the light-shielding dots 232 can be different. In this embodiment, the outer diameters of the light-shielding dots 232 are between 0.01 mm and 0.13 mm. Moreover, the shapes of the light-shielding dots 232 can also be different. They can be circular, polygonal, elliptical, etc. The color of the light-shielding dots 232 can be black, gray, or white. When they are black or gray, the light-shielding dots 232 absorb light. When they are white, the light-shielding dots 232 reflect light.

In this embodiment, the light-shielding dots 232 have different densities as one moves away from the edge 2312. This can be achieved by changing, for example, the sizes or numbers of the light-shielding dots 232. Generally speaking, the light intensity gets stronger while approaching the light source 21. Therefore, the density of the light-shielding dots 232 closer to the edge 2312 is larger than the density of those farther away from the edge 2312 (see the two exploded views in FIG. 5). In this embodiment, the light-shielding dots 232 closest to the edge 2312 can block about 95% of the light. The light-shielding dots 232 farthest from the edge 2312 can block 5% of the light. The light-blocking rate of the light-shielding dots 232 gradually decreases from 95% to 5% as it gets away from the edge 2312.

In the embodiment, the light-shielding dots 232 at a first distance from the edge 2312 have a 95% light-blocking rate. The light-shielding dots 232 at a second distance from the edge 2312 have a 5% light-blbcking rate. Here the first distance is roughly equal to the largest thickness T of the LGP 22 (FIG. 4), and the second distance is roughly three times the largest thickness T of the LGP 22. It should be noted that the LGP 22 in FIG. 4 is exaggerated and schematic. The largest thickness T of the LGP 22 is usually very small, such as 2.2 mm.

In this embodiment, the optical diffusing sheet 23 can be a relatively thick diffuser plate or a relatively thin diffuser film. The light-shielding dots 232 can be formed by ink printing. To enhance the light-blocking effect, a light-blocking strap 233 can be disposed adjacent to the edge 2312 of the body 231, between the edge 2312 and the light-shielding dots 232. Of course, the light-blocking strap 233 has to be disposed outside the visible region in order not to block any light from the visible region. In this embodiment, the light-blocking strap 233 is formed by gray ink printing.

Please refer again to FIG. 4 to clarify the optical path of the backlight module 2. When the light source 21 emits light, the beam enters the LGP 22 via the light incident surface 221 and experiences total reflection inside the LGP 22. When the light reaches the printing dots 224 on the LGP 22, scattering occurs to destroy the total reflection of light. A portion of light is deflected to leave the LGP 22 via the light outgoing surface 222. When the light passes through the optical diffusing sheet 23, it is redistributed by the optical diffusing sheet 23 to become more uniform. On the other hand, the light-shielding dots 232 and the light-shielding strap 233 absorb or reflect some of the light to render more uniform light emission from the backlight module 2.

With further reference to FIG. 3, the backlight module 2 can further include an optical film set 24 disposed adjacent to the optical diffusing sheet 23. In this embodiment, the optical film set 24 can include a brightness enhancement film (BEF), such as a prism sheet, to enhance the light-emitting intensity in the direction perpendicular to the light outgoing surface 222.

In other embodiments of the invention, the backlight module 2 can have another optical diffusing sheet as a top diffuser or a bottom diffuser. In this case, the light-shielding dots 232 can be disposed on either the top diffuser or the bottom diffuser, or simultaneously on both the top diffuser and the bottom diffuser, depending on how the best effect can be achieved in practice.

In summary, the optical diffusing sheet and the backlight module of the invention have a body and a plurality of light-shielding dots. The light-shielding dots are disposed on a surface of the body, adjacent to the edge of the surface. At least a portion of the adjacent light-shielding dots have different intervals. The light-shielding dots can absorb or reflect some of the light in the vicinity of the light source, so that the brightness of the light-emitting area is more uniform. In comparison with the prior art, at least a portion of the light-shielding dots of the optical diffusing sheet have different intervals and sizes. Therefore, they do not block the pixel light in a regular way. This prevents the occurrence of mura defects. The areas of most of the light-shielding dots in the invention are smaller than those of conventional light-shielding dots. Therefore, the pixels are less blocked and the light-emission is thus increased. Moreover, the light-shielding dots are disposed irregularly such that the light-blocking rate is higher in the vicinity of the light source, and gets lower as it goes away from the light source. This renders a more uniform light distribution. Therefore, the invention can increase the light-emitting efficiency of the entire backlight module and improve the image quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical diffusing sheet, comprising:
a body; and
a plurality of light-shielding dots, which are disposed on a surface of the body and adjacent to an edge of the body, wherein at least a portion of the adjacent light-shielding dots have different intervals.

2. The optical diffusing sheet of claim 1, wherein the outer diameters of the light-shielding dots are between 0.01 mm and 0.13 mm.

3. The optical diffusing sheet of claim 1, wherein the intervals are determined within a distance range by random sampling.

4. The optical diffusing sheet of claim 1, wherein the density of the light-shielding dots closer to the edge is greater than the density of the light-shielding dots farther away from the edge.

5. The optical diffusing sheet of claim 1, wherein the light-shielding dots at a first distance from the edge has a light-blocking rate of about 95%.

6. The optical diffusing sheet of claim 5, wherein the first distance is roughly equal to the largest thickness of a light guiding plate disposed in the vicinity of the body.

7. The optical diffusing sheet of claim 1, wherein the light-shielding dots at a second distance from the edge has a light-blocking rate of about 5%.

8. The optical diffusing sheet of claim 7, wherein the second distance is roughly equal to three times of the largest thickness of a light guiding plate disposed in the vicinity of the body.

9. The optical diffusing sheet of claim 1, wherein the light-shielding dots are gray, black, or white.

10. The optical diffusing sheet of claim 1, wherein each of the light-shielding dots is circular, polygonal, or elliptical.

11. A backlight module, comprising:
a light source;
a light guiding plate (LGP), which is disposed in the vicinity of the light source; and
an optical diffusing sheet, which is disposed on a light outgoing surface of the LGP and comprises:
a body, and
a plurality of light-shielding dots, which are disposed on a surface of the body and adjacent to an edge of the body, wherein at least a portion of the adjacent light-shielding dots have different intervals.

12. The backlight module of claim 11, wherein the outer diameters of the light-shielding dots are between 0.01 mm and 0.13 mm.

13. The backlight module of claim 11, wherein the intervals are determined within a distance range by random sampling.

14. The backlight module of claim 11, wherein the density of the light-shielding dots closer to the edge is greater than the density of the light-shielding dots farther away from the edge.

15. The backlight module of claim 11, wherein the light-shielding dots at a first distance from the edge has a light-blocking rate of about 95%.

16. The backlight module of claim 15, wherein the first distance is roughly equal to the largest thickness of a light guiding plate disposed in the vicinity of the body.

17. The backlight module of claim 11, wherein the light-shielding dots at a second distance from the edge has a light-blocking rate of about 5%.

18. The backlight module of claim 17, wherein the second distance is roughly equal to three times of the largest thickness of a light guiding plate disposed in the vicinity of the body.

19. The backlight module of claim 11, wherein the light-shielding dots are gray, black, or white.

20. The backlight module of claim 11, wherein each of the light-shielding dots is circular, polygonal, or elliptical.

21. The backlight module of claim 11, wherein the body of the optical diffusing sheet comprises a light-blocking strap, and the light-blocking strap is disposed adjacent to the edge of the body.

22. The backlight module of claim 11, wherein the light source is disposed adjacent to the edge of the body.

23. The backlight module of claim 11, further comprising an optical film set disposed adjacent to the optical diffusing sheet.
